(19) United States
(12) Patent Application Publication
(10) Pub. No.: US 2023/0328775 A1
(43) Pub. Date: Oct. 12, 2023

(54) SYSTEMS AND METHODS FOR CHANGING LBT FOR UNLICENSED NETWORKS

(71) Applicant: Telefonaktiebolaget LM Ericsson (publ), Stockholm (SE)

(72) Inventors: Tai Do, Lund (SE); Peter Alriksson, Hörby (SE); Reem Karaki, Aachen (DE); Aliakbar Mirzaei, Lund (SE); Havish Koorapaty, Saratoga, CA (US); Yuhang Liu, Lund (SE)

(21) Appl. No.: 18/021,192

(22) PCT Filed: Aug. 13, 2021
(86) PCT No.: PCT/EP2021/072637

§ 371 Date: Feb. 14, 2023

Related U.S. Application Data
(60) Provisional application No. 63/065,945, filed on Aug. 14, 2020.

(51) Int. Cl. H04W 74/08

(52) U.S. Cl. CPC H04W 74/0808; H04W 16/14

(57) ABSTRACT

Systems and methods for changing Listen Before Talk (LBT) for unlicensed networks are provided. In some embodiments, a method performed by a wireless device includes: receiving signaling from a base station that indicates when the wireless device uses LBT for transmissions; determining, based on the received signaling, whether or not to use LBT for transmissions; and transmitting based on the determination whether or not to use LBT for transmissions. Some embodiments provide a low complexity (in term of signaling overhead and specification impact) approach of adaptively using LBT mechanism by defining two simple modes for LBT operation (LBT and No LBT modes). Some embodiments reduce the probability of simultaneous transmissions that cause collisions, by using LBT mode, in environments and circumstances where network performance suffers from collision and/or interferences.

### RELATED APPLICATIONS

This application claims the benefit of provisional patent application Ser. No. 63/065,945, filed Aug. 14, 2020, the disclosure of which is hereby incorporated herein by reference in its entirety.

### TECHNICAL FIELD

The present disclosure relates generally to using Listen Before Talk (LBT) for transmissions.

### BACKGROUND

New Radio (NR) in Unlicensed Spectrum (NR-U)

Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that allow an efficient use of it as a complement to licensed deployments have the potential to bring great value to the Third Generation Partnership Project (3GPP) operators, and, ultimately, to the 3GPP industry as a whole. This type of solutions would enable operators and vendors to leverage the existing or planned investments in Long Term Evolution (LTE)/NR hardware in the radio and core network.

For a node to be allowed to transmit in unlicensed spectrum in lower frequency band, it typically needs to perform a Clear Channel Assessment (CCA) or Listen Before Talk (LBT). This procedure typically includes sensing the wireless medium to be unoccupied. Sensing the medium to be idle can be done in different ways, e.g., using energy detection, preamble detection or using virtual carrier sensing. Where the former implies that the node listens to the channel and measures the energy of the interference (plus noise) for a number of time intervals. If the energy is smaller than a certain threshold (often called Energy Detection (ED) threshold), it declares that the medium is idle. Otherwise, it declares that the medium is busy (or occupied).

After sensing the medium to be idle, the node is typically allowed to transmit for a certain duration, sometimes referred to as Transmission Opportunity (TXOP) or COT (Channel Occupancy Time). In some jurisdictions, the maximum duration of a COT depends on the type of CCA that has been performed. Typical ranges are 1 ms to ms. This limit is denoted Maximum Channel Occupancy Time (MCOT). During a COT a New Radio Base Station (gNB) is allowed to share its access to the wireless medium with uplink transmissions from User Equipments (UEs). Sometimes, this is referred to as shared COT. A major goal of introducing the shared COT concept is to minimize the need of UEs to perform a long LBT prior to transmissions in the uplink. In some jurisdictions, a scheduled UE is permitted performing a short LBT immediately following the downlink transmission.

NR-U Operation in High Frequency Spectrum

RP-193259, New SID: Study on supporting NR from 52.6 GHz to 71 GHz and RP-193229, New WID on Extending current NR operation to 71 GHz were approved in RAN #86 to study and extend NR support in the frequency range of 52.6 GHz to 71 GHz. One of the main objectives of this Study Item (SI) and Work Item (WI) is the study of channel access mechanism, considering potential interference to/from other nodes, assuming beam based operation, in order to comply with the regulatory requirements applicable to unlicensed spectrum for frequencies between 52.6 GHz and 71 GHz.

Regulatory Requirements

In Europe and European Conference of Postal and Telecommunications Administrations (CEPT), the new frequency bands and regulatory parameters for the 57-71 GHz band for Wideband Data Transmission Systems are defined in ERC/REC 70-03. Corresponding updates have also been made to the technical annex of EC Decision 2006/771/EC for short range devices (SRD) in 2019. ERC/REC 70-03 defines three sub-bands in the 57-71 GHz band as summarized in in Table 1.

TABLE 1
Regulatory parameters for Wideband Data Transmission Systems

| | | | Spectrum | Modulation/ | | |
|---|---|---|---|---|---|---|
| | | | access and | maximum | | |
| Frequency | | Power/ | mitigation | occupied | ECC/ERC | |
| Band | | Magnetic Field | requirements | bandwidth | deliverable | Notes |
| c1 | 57-71 | 40 dBm EIRP, 23 | Adequate | Not | | Fixed |
| | GHz | dBm/MHz EIRP | spectrum | specified | | outdoor |
| | | density | sharing | | | installations |
| | | | mechanism | | | are not |
| | | | shall be | | | allowed. |
| | | | implemented | | | |
| c2 | 57-71 | 40 dBm EIRP, 23 | Adequate | Not | ECC Report | |
| | GHz | dBm/MHz EIRP | spectrum | specified | 288 | |
| | | density and | sharing | | | |
| | | maximum | mechanism | | | |
| | | transmit power | shall be | | | |
| | | of 27 dBm at the | implemented | | | |
| | | antenna port or | | | | |
| | | ports | | | | |
| c3 | 57-71 | 55 dBm EIRP, 38 | Adequate | Not | ECC Report | Applies only |
| | GHz | dBm/MHz EIRP | spectrum | specified | 288 | to fixed |
| | | density and | sharing | | | outdoor |
| | | transmit antenna | mechanism | | | installations. |
| | | gain ≥30 dBi | shall be | | | |
| | | | implemented | | | |

CEPT mandates implementing adequate spectrum sharing mechanism for operation in 57-71 GHz. Those mechanisms can differ from one technology to another. Some exemplary mechanisms include: Automatic Transmit Power Control (ATPC) and Listen Before Talk (LBT). Hence, in principle LBT is not mandated by CEPT.

Among the spectrum allocations for U.S.A., frequency ranges 57 GHz to 71 GHz are available for mobile use as part of unlicensed spectrum regulated by Title 47 Part 15 of the FCC regulations. Spectrum access and mitigation requirements are not specified. Instead, only requirements on transmission power limits in terms of Effective Isotropically Radiated Power (EIRP) and/or maximum conducted output power are specified.

Similarly, countries in ITU region 2 and 3 only specify transmission power limits in terms of EIRP and/or maximum conducted power. LBT is not required in these countries either.

Energy Detection Threshold Adaptation for NR

Some disclosures discuss various methods for adapting the ED threshold. Some disclosures discuss various methods for fractional frequency reuse of resources with flexible energy detection where different resources in time, frequency, or space use different energy detection thresholds.

It should be noted that setting the ED threshold to a very high value (Infinity) is not equivalent to no LBT mode, because even if the ED threshold is very high, the transmitter still need to defer and sense the channel, thus additional overhead is added. Improved systems and methods for transmitting with or without LBT are needed.

### SUMMARY

Systems and methods for changing Listen Before Talk (LBT) for unlicensed networks are provided. In some embodiments, a method performed by a wireless device includes: receiving signaling from a base station that indicates when the wireless device uses LBT for transmissions; determining, based on the received signaling, whether or not to use LBT for transmissions; and transmitting based on the determination whether or not to use LBT for transmissions.

In some embodiments, a method of determining and signaling the LBT mode (LBT or no LBT) according to the network's status is considered, wherein: The New Radio Base Station (gNB)/User Equipment (UE) determines LBT mode statically or dynamically based on the long term or short term status of the network. The gNB uses or does not use LBT mode for downlink (DL) transmissions and/or signals to the UE(s) the LBT mode to be used for the next uplink (UL) transmissions or alternatively configures the UE with a set of rules based on which the UE can determine the LBT mode by itself.

Without loss of any generality, the method is described for New Radio Unlicensed Spectrum (NR-U) but can also be applied to other Radio Access Technologies (RATs).

There are, proposed herein, various embodiments which address one or more of the issues disclosed herein.

Certain embodiments may provide one or more of the following technical advantage(s). Some embodiments provide a low complexity (in term of signaling overhead and specification impact) approach of adaptively using LBT mechanism by defining two simple modes for LBT operation (LBT and No LBT modes).

The method reduces the probability of simultaneous transmissions that cause collisions, by using LBT mode, in environments and circumstances where network's performance suffers from collision and/or interferences. On the other hand, the method improves the spatial frequency reuse and reduces LBT overhead by using no LBT mode if it is allowed by relevant regional regulations or if devices experience less interference from simultaneous transmissions. Thus, the method improves the overall spectral efficiency by identifying and switching to the appropriate mode.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a fractional frequency/time reuse in a cellular network with the two shades representing non-overlapping sets of frequency/time use, according to some embodiments of the present disclosure;

FIG. 3 is a schematic block diagram of a radio access node according to some embodiments of the present disclosure;

FIG. 4 is a schematic block diagram that illustrates a virtualized embodiment of the radio access node according to some embodiments of the present disclosure;

FIG. 5 is a schematic block diagram of the radio access node according to some other embodiments of the present disclosure;

FIG. 6 is a schematic block diagram of a wireless communication device according to some embodiments of the present disclosure;

FIG. 7 is a schematic block diagram of the wireless communication device according to some other embodiments of the present disclosure;

FIG. 8 illustrates a communication system includes a telecommunication network, such as a Third Generation Partnership Project (3GPP) type cellular network, which comprises an access network, such as a Radio Access Network (RAN), and a core network according to some embodiments of the present disclosure;

FIG. 9 illustrates a communication system including a host computer according to some embodiments of the present disclosure; and

FIGS. 10-13 are flowcharts illustrating methods implemented in a communication system, according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

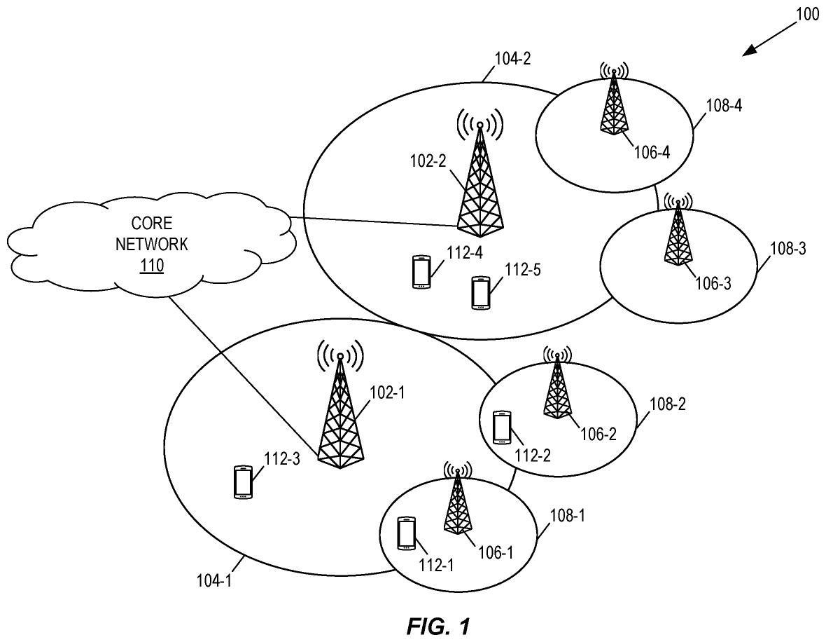

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

Listen Before Talk (LBT) has been used as a medium access mechanism for unlicensed spectrum in lower frequency ranges, e.g., 2.4 and 5 GHz bands. However, since the millimeter wave frequency range is characterized by high radio propagation loss and directional transmission and reception from the usage of large antenna arrays, LBT is generally not beneficial. The intra and inter system interference condition in the 60 GHz band (or other higher frequency bands) is considerably different compared to lower frequency bands.

Firstly, the transmission power limitation imposed by different regulations and the attenuation characteristics around the 60 GHz range prohibits radio signal to cause strong interference to other nodes located tens of meters away. Secondly, highly directional signal transmission is less likely to interfere with other nodes even in the close vicinity, except for the nodes that lie directly in the transmission beam coverage. The probability of interference is further reduced for the nodes that employ directional reception. Thirdly, highly directional transmission also makes it very difficult for a transmitter to correctly detect the interference level at intended receiver, and hence the fundamental assumption in classical LBT for interference avoidance no longer holds.

LBT requirement is not mandatory in most regions and regulations. In many cases it negatively impacts on the system performance at 60 GHz due to the unnecessary back-off delay from LBT.

Even though this can be true in most cases, there can be cases in which these assumptions do not hold. For instance, not all equipment's are capable of transmitting with high directivity. Besides, cell edge UEs are more subject to interference than other UEs. Interference from neighboring cells can significantly impact the performance. Finally, as the number of nodes increase, the probability of being impacted by interference becomes higher. In such cases, using LBT to avoid collisions and interference from other nodes may have a positive impact on the performance.

Hence, it is beneficial for a wireless radio access network to statically or dynamically switch on or off LBT, based on the operation frequency bands, spectrum congestion level, system traffic level, devices capabilities, etc., to improve overall system performance.

Systems and methods for changing LBT for unlicensed networks are provided. In some embodiments, a method performed by a wireless device includes: receiving signaling from a base station that indicates when the wireless device uses LBT for transmissions; determining, based on the received signaling, whether or not to use LBT for transmissions; and transmitting based on the determination whether or not to use LBT for transmissions.

Some embodiments provide a low complexity (in term of signaling overhead and specification impact) approach of adaptively using LBT mechanism by defining two simple modes for LBT operation (LBT and No LBT modes).

The method reduces the probability of simultaneous transmissions that cause collisions, by using LBT mode, in environments and circumstances where network's performance suffers from collision and/or interferences. On the other hand, the method improves the spatial frequency reuse and reduces LBT overhead by using no LBT mode if it is allowed by relevant regional regulations or if devices experience less interference from simultaneous transmissions. Thus, the method improves the overall spectral efficiency by identifying and switching to the appropriate mode.

In some embodiments, a UE does not even have LBT implemented if certain hardware conditions are fulfilled.

### Embodiment #1: LBT Switching Based on Network Configuration

In this embodiment, a method in which a device may operate without LBT is based the configuration of the systems, device hardware capabilities, or predefined rules, which is satisfied one or more of the following thresholds or conditions:
The number of antennas at the transmitter is larger than a certain threshold.
The number of antennas to be considered could be the total equipped antennas or a sub-set of total antennas used for transmitting.
The directivity of the transmissions from the transmitter is larger than a certain threshold.
   The directivity to be considered includes beamforming gain and antenna gain.
   The beamforming gain to be considered could be long-term averaged or instantaneous.
The transmit power or Effective Isotropically Radiated Power (EIRP) is smaller than a certain threshold. The transmit power and EIRP to be considered could be average or peak power.
The transmit duration or duty cycle is smaller than a certain threshold. For instance, if the transmit duration is long, the LBT overhead is minimal, so LBT can be performed to avoid collisions before a long transmission.
The scenario of network, e.g., controlled environment, or no coexistence with other networks, or no coexistence with other technologies. Input to this could be:
   Configured information in the gNB (configured through operation and maintenance means).
   Information collected from Automatic Neighbor Relation (ANR) reports or similar reports from UEs about the presence of neighbor cells, gNBs, access points, networks, etc. in the area.
   Information collected from centralized spectrum allocation entities.

In this embodiment, the devices could transmit without performing LBT prior to the transmission based on:
Signaling from the gNB that indicate to the UE that it may transmit without LBT.
The indication can be based on Radio Resource Control (RRC) configuration or signaled via Medium Access Control Control Element (MAC-CE) or Downlink Control Information (DCI). E.g.,
   No LBT mode indication from gNB via system information broadcasting.
   No LBT mode activation from gNB via dedicated RRC signaling. The device will use no LBT mode until receiving another notification from gNB or based on a timer.
   No LBT mode activation from gNB via MAC CE. The device will use no LBT mode until receiving another notification from gNB or based on a timer.
   No LBT mode indication via the UL grant from gNB, e.g., gNB signal cat1 LBT in DCI for each transmission
Alternatively, the gNB indicates to the UE the conditions in which it is allowed to transmit without performing an LBT. Accordingly, the device could operate without LBT or change from LBT to no LBT mode by itself if the above thresholds or conditions are satisfied. For instance, the device is RRC configured with those thresholds or conditions.

Without loss of generality, the method is described for New Radio Unlicensed Spectrum (NR-U) but can also be applied to other RATs.

### Embodiment #2: LBT Switching Based on Measurement

Embodiment #2a: In this embodiment, the gNB/UE determines to use LBT or no LBT mode based on the collision rates or unsuccessful transmission rate of the downlink (DL) or/and uplink (UL) transmissions observed over a certain period. For example, if the gNB/UE counts the number of Negative Acknowledgement (NACK) over an observation period is larger than a certain threshold, it will change from no LBT to LBT mode.
Embodiment #2b: Similar to embodiment #2a, the gNB/UE measures the Acknowledgement (ACK)/NACK ratio over a period of time and tries to keep it at a particular target (e.g., 10%) using a control loop. That is, if ACK/NACK ratio is larger than the target, LBT mode is used. Otherwise, no LBT mode is used.
Embodiment #2c: In this embodiment, the gNB determines to use LBT or no LBT mode based on the current or typical situation of aspects impacting interference between nodes and devices in the area, e.g., the number active UEs in the gNB's cell (and neighbor cell), the traffic load measured by one or more metrics, e.g., the packet arrival rate, and so on.
Embodiment #2da: In this embodiment, the gNB determines to use LBT or no LBT mode based on the Signal to Interference plus Noise Ratio (SINR) of the uplinks for the UEs being served by the gNB. For example, if the SINR of some function of the serving links is lower than a certain threshold, LBT mode is used. The function could be the minimum SINR among the UEs being served, a linear average of the SINR. It will be obvious to those skilled in the art that other functions may be used as well as part of this embodiment.
Embodiment #2db: In this embodiment, the UE determines to use LBT or no LBT mode based on the SINR of the downlink from the gNB. For example, if the SINR is lower than a certain threshold, LBT mode is used.
Embodiment #2e: In this embodiment the modulation and coding scheme (MCS) is jointly chosen together with the LBT mode. For example, a no LBT mode is chosen in combination with a more robust (lower) MCS and vice versa,
Embodiment #2f: In this embodiment the latency requirement of the data to be sent is taken into account. For example, for urgent traffic a more robust (lower) MCS in combination with no LBT mode can be used and for best effort traffic a less robust (higher) MCS in combination with LBT mode can be used.
Embodiment #2ga: In this embodiment the gNB determines to use LBT or no LBT mode based at least in part on gNB declaration of radio link failure. For example, if the maximum number of Hybrid Automatic Repeat Request (HARQ) and Radio Link Control (RLC) retransmissions is reached creating a gNB declared Radio Link Failure (RLF), this can be a sign that the UEs are experiencing heavy interference or the medium is highly utilized causing excessive LBT failures. In response, LBT mode could be used.
Embodiment #2gb: In this embodiment the UE determines to use LBT or no LBT mode based at least in part on its declaration of radio link failure. For example, if the maximum number of HARQ and RLC retransmissions is reached creating RLF, this can be a sign that the gNB is experiencing heavy interference or the medium is highly utilized causing excessive LBT failures. In response, LBT mode could be used.
Embodiment #2gc: In this embodiment the gNB determines to use LBT or no LBT mode based at least in part on its declaration of layer 1 control message failure (DCI and/or Uplink Control Information (UCI)). For example, if the maximum number of Physical Downlink Control Channel (PDCCH) transmission failure (due to LBT failure) and/or PUCCH miss-detection is reached creating a reliability deterioration of Layer 1 control signaling, this can be a sign that the gNB is experiencing heavy interference or the medium is highly utilized causing excessive LBT failures. In response, LBT mode could be used.
Embodiment #2gd: In this embodiment the gNB determines to use LBT or no LBT mode based at least in part on the Channel State Information (CSI) measurement report from the UEs. For example, if the CSI reports from UEs indicate strong inter-cell or inter-network interference, this can be a sign that the UEs are experiencing heavy interference or the medium is highly utilized causing excessive LBT failures. In response, LBT mode could be used.
Embodiment #2h: In this embodiment, the gNB determines to use LBT or no LBT mode based at least in part on UE declaration of radio link failure and subsequent RRC Connection Re-establishment attempts. For example, the UE performs radio link monitoring (RLM) on the link to the serving cell. The RLM procedure can account for failed LBT procedures which factor into when the UE declares an RLF. The gNB can observe statistics on RLFs from the fleet of UEs based on RRC connection re-establishment attempts. If there is a high rate of re-establishment attempts, the LBT mode could be used.
Embodiment #2ia: In this embodiment, the gNB/UE determines LBT or no LBT mode based on the average measured energy on the channel, i.e., the energy detected over a certain time duration where the time duration may be greater than the measurement slot sizes used in the LBT procedure. If the average measured energy on the channel is larger than a certain threshold, no LBT could be used.
Embodiment #2ib: In this embodiment, the gNB/UE determines LBT or no LBT mode based on the RSSI measurement on the operation channel during idle time (i.e., no active DL or UL transmission in the cell) within a certain time window. If the measured Received Signal Strength Indicator (RSSI) during idle time is below a certain threshold, no LBT could be used.
Embodiment #2ja: In this embodiment, the gNB determines LBT or no LBT mode based on the one or a combination of more than one set of statistics from all or a subset of the active UEs. As a non-limiting example, some combination of metrics such as the successful packet receive ratio, obtained SINR, ratio of cancelled UL transmissions due to LBT failure, etc. could be used to adapt the mode of operation.
Embodiment #2jb: In this embodiment, the UE determines LBT or no LBT mode based on the one or a combination of more than one set of statistics. As a non-limiting example, some combination of metrics such as the successful packet receive ratio, obtained SINR, ratio of cancelled UL transmissions due to LBT failure, etc. could be used to adapt the mode of operation.
Embodiment #2k: In this embodiment, the gNB/UE determines LBT or no LBT mode based on the receiver sensitivity measured by the received signal strength corresponding to the lowest successful MCS received from the UE/gNB over an observation period. As a non-limiting example, no LBT could be used when lower values for the receiver sensitivity are detected and vice-versa.
Embodiment #21: the gNB/UE determines LBT or no LBT mode based on the type of transmission or signal. For example, control signals (e.g., Physical Uplink Control Channel (PUCCH), Physical Random Access Channel (PRACH), and Synchronization Signal Block (SSB)) are sent without LBT, and data transmissions (Physical Uplink Shared Channel (PUSCH), Physical Downlink Shared Channel (PDSCH)) are sent with LBT.
Embodiment #2m: the gNB/UE determines LBT or no LBT mode based on a combination of any of those methods in Embodiments above.
Embodiment #2n: The LBT or no LBT mode is chosen based at least in part on information of how harmful interference (if any) the transmitter would cause for other devices in the area. This is difficult to measure, but information from neighboring gNBs can provide relevant information, e.g., average SINR experienced by the neighbor gNB and/or by the neighbor gNB's UEs.
Embodiment #20: The LBT or no LBT mode is chosen based at least in part on information of how often the receiver fails to receive the transmission, or what SINR the receiver of the transmission experiences.
Embodiment #2pa: The gNB can choose the LBT or no LBT mode based at least in part on statistics of the detected energy level. The gNB can get this information by recording its own sensing of the channel and by collecting statistics from UEs. UEs can report this on request and/or they could be configured to record such measurement data continuously or repeatedly while in RRC_IDLE, RRC_INACTIVE and/or RRC_CONNECTED state and later report the recorded data, e.g., on request or triggered by certain events, such as state switching (e.g., transition from RRC_IDLE or RRC_INACTIVE to RRC_CONNECTED state) and/or if/when a certain amount of data has been recorded. The reporting can be based on the raw measurements or certain statistics can be reported, e.g., minimum and maximum observed energy levels within a time window, the variance within a time window, or the average lengths of time windows where energy is received above a certain threshold.
Embodiment #2pb: The UE can choose the LBT or no LBT mode based at least in part on statistics of the detected energy level. The UE can get this information by recording its own sensing of the channel and by signaling from the gNB. UE can report this on request and/or they could be configured to record such measurement data continuously or repeatedly and later report the recorded data, e.g., on request or in system information. The reporting can certain statistics, e.g., minimum and maximum observed energy levels within a time window, the variance within a time window, or the average lengths of time windows where energy is received above a certain threshold.
Embodiment #2q: The device observes the wireless medium and records the duration that the wireless medium remains unoccupied between transmissions. In observing these unoccupied periods, the device builds statistics including statistics on the idle times between channel occupancies. Based on the statistics, the device optimizes the LBT or no LBT mode. E.g., if statistical data indicates that many transmissions occur after the shortest duration permitted by regulatory requirements there are many devices competing for access to the wireless medium. Consequently, LBT mode could be used.
Embodiment #2r: In this embodiment, the gNB/UE selects LBT or no LBT mode based on a combination of one or more performance metrics such as cell throughput, user throughput including mean and fifth percentile throughput, mean latency, fifth percentile latency etc. The performance metrics are based on long term collection of statistics at the gNB/UE for both the DL and the UL.
Embodiment #2s: In this embodiment, the different LBT mode could be selected for different signals. For instance, the LBT mode can be different for e.g., Random Access (and different triggers for Random Access (RA)) than for other data transmissions. One could for example have the no LBT mode also for the RA triggers (Handover (HO), UL synch when new data, SR failure).

### Embodiment #3: LBT Mode Signaling/Configuration

As a main aspect of this embodiment, the LBT mode is signaled using L1 signaling. As a non-limiting example, the gNB may send LBT mode updates as part of DL scheduling assignment, UL scheduling assignment, or DCIs for other purposes. The signaling may be group common, or UE specific.
Embodiment #3a: In this embodiment, the gNB signals the LBT mode to the UEs via UL grant. In order to minimize the specification impact, the LBT mode can be signaled together with LBT category in rel-16.
Embodiment #3b: In this embodiment, the gNB signals the LBT mode to the UEs via Group Communication (GC)-PDCCH. In order to minimize the signaling overhead, the LBT mode could be signaled on a per need basis, i.e., when the gNB sees the need of updating the LBT mode.
Embodiment #3c: In this embodiment, LBT mode could be signaled via both UL grant, GC-PDCCH (and via RRC). Then, the priority of which signal can be overwritten by which signal is pre-configured. For example, the priority could be on time (the former signaling is overwritten by the later regardless of the signal's category) or could be on categories (Energy Detection (ED) threshold in UL grant is overwritten by the one in GC-PDCCH). Alternatively, it could be the other way around, i.e., the LBT mode received in UE-specific DCI with an UL grant should overwrite the group common LBT mode threshold in GC-PDCCH.
Embodiment #3d: In this embodiment, the gNB can signal different LBT mode to different UEs. For example, if the interference is very different for different UEs due to separated locations, it could be useful to allow different UEs to use different LBT mode.
Embodiment #3e: In this embodiment, when the LBT mode is only signaled on a per need basis, the UEs will use the latest LBT mode they received from the gNB.
Embodiment #3f: In this embodiment the LBT mode is transmitted as part of system information (typically System Information Broadcasting (SIB)1). The LBT mode in the system information can be used by UEs for transmissions related to initial access or for other than those needed in conjunction with initial access. In another variation, the LBT mode information in the system information may also contain diverse LBT mode information to allow the UE to autonomously select the LBT mode within certain limits (e.g., based on the UE's current situation), conditions associated with the use of each one of LBT mode.
Embodiment #3g: In this embodiment the gNB signals LBT mode updates in Short Message DCI (e.g., addressed to Paging-Radio Network Temporary Identifier (P-RNTI) or some other Radio Network Temporary Identifier (RNTI)) with indication of LBT mode change (explicit value, +/−steps or instruction to check new LBT mode in the system information). Optionally, the DCI can also contain an indication of either immediate application or later application. Later application could be e.g., at a certain system frame number, a certain time (e.g., expressed in milliseconds or slots), at the next system information modification period boundary, etc.
Embodiment #3h: In this embodiment the gNB signals LBT mode updates using predefined RNTIs, e.g., where one RNTI could mean LBT mode, another RNTI could mean no LBT mode.
Embodiment #3i: In this embodiment, the LBT mode is signaled through group addressed beacon frames (messages) or individually addressed probe frames (messages).

### Embodiment #4

In a scenario where operating with LBT is mandatory, or if the gNB determines that operation with LBT is beneficial, and the UE does not support LBT, the gNB makes sure that the UE UL transmissions are part of the gNB's initiated COT.

### Embodiment #5

In this embodiment, the switching of LBT modes is between a frame based equipment (FBE) mode and a load based equipment (LBE) mode. The modes could then also be configured with appropriate energy detection thresholds. For example, the energy detection threshold for FBE can be set very high so that there is effectively no LBT performed, except for a 9 microsecond delay prior to transmission since FBE only requires sensing in a single slot.

### Embodiment #6

In this embodiment, the switching of LBT modes is between two LBE modes where one has random exponential backoff and one doesn't. For instance, in the LBE mode without any backoff, the gNB or UE always chooses a random counter between 0 and Contention Window (CW), where CW is fixed. In the LBE mode with backoff, this CW is increased (e.g., doubled) when a transmission is detected to not be successful, for instance through the reception of a negative acknowledgement. Again, as in the previous embodiment, the energy detection thresholds can be varied based on the level of reuse desired between resources in different cells.

### Embodiment #7

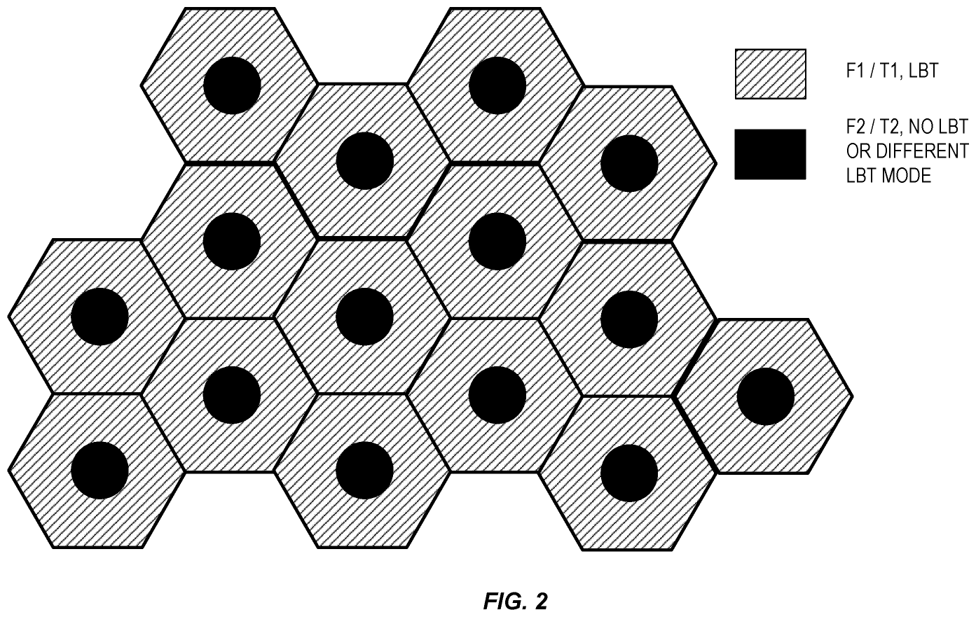

In this embodiment, the LBT mode used is chosen based on the time, frequency or spatial resources being used for a particular transmission. Furthermore, the configuration of the resources can be coordinated between cells to enable LBT for UEs operating at the cell edge (both on the downlink and uplink) while disabling or modifying the mode significantly for UEs operating closer to the gNB. An exemplary example of this is shown in FIG. 2. FIG. 2 illustrates a fractional frequency/time reuse in a cellular network with the two shades representing non-overlapping sets of frequency/time use.

### Embodiment #8

In this embodiment, the LBT mode is configured as part of the bandwidth part configuration. UEs may be configured with more than one bandwidth part with each bandwidth part being configured with a different LBT mode. The gNB can control the LBT modes used by the choice of bandwidth part used for communication with the UE.

### Embodiment #9

In this embodiment, the UE may be configured with different LBT modes for different DCI formats. For instance, the UE could be configured to receive PUSCH scheduling via DCI format 0_1 and 0_2 each of which has its own time domain resource allocation (TDRA) table. The UE could be configured with a different LBT mode for these DCI formats. For instance, the network could configure the UE to associate PUSCH allocations signaled via DCI format 0_1 to not use LBT while allocations signaled via DCI format 0_2 may use LBT. Any of the different LBT modes or associated parameters can be configured for each of these DCI formats.

It will be obvious to those skilled in the art that any of the previous embodiments can be used in combination with each other. For instance, the Time Domain Resource Allocation (TDRA) tables for DCI formats 0_1 and 0_2 could be configured to emulate the fractional frequency/time reuse schemes in the FIG. 2 by configuring different resources signaled by different DCI formats.

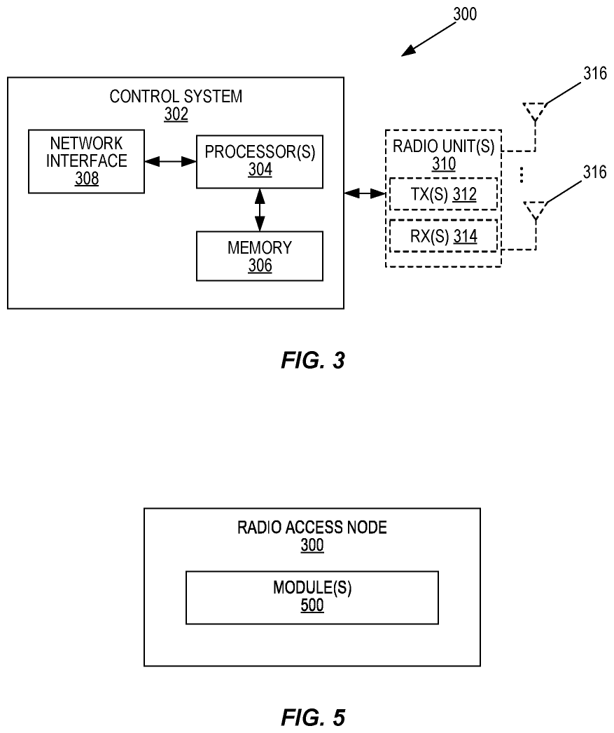

FIG. 3 is a schematic block diagram of a radio access node 300 according to some embodiments of the present disclosure. Optional features are represented by dashed boxes. The radio access node 300 may be, for example, a base station 102 or 106 or a network node that implements all or part of the functionality of the base station 102 or gNB described herein. As illustrated, the radio access node 300 includes a control system 302 that includes one or more processors 304 (e.g., Central Processing Units (CPUs), Application Specific Integrated Circuits (ASICs), Field Programmable Gate Arrays (FPGAs), and/or the like), memory 306, and a network interface 308. The one or more processors 304 are also referred to herein as processing circuitry. In addition, the radio access node 300 may include one or more radio units 310 that each includes one or more transmitters 312 and one or more receivers 314 coupled to one or more antennas 316. The radio units 310 may be referred to or be part of radio interface circuitry. In some embodiments, the radio unit(s) 310 is external to the control system 302 and connected to the control system 302 via, e.g., a wired connection (e.g., an optical cable). However, in some other embodiments, the radio unit(s) 310 and potentially the antenna(s) 316 are integrated together with the control system 302. The one or more processors 304 operate to provide one or more functions of a radio access node 300 as described herein. In some embodiments, the function(s) are implemented in software that is stored, e.g., in the memory 306 and executed by the one or more processors 304.

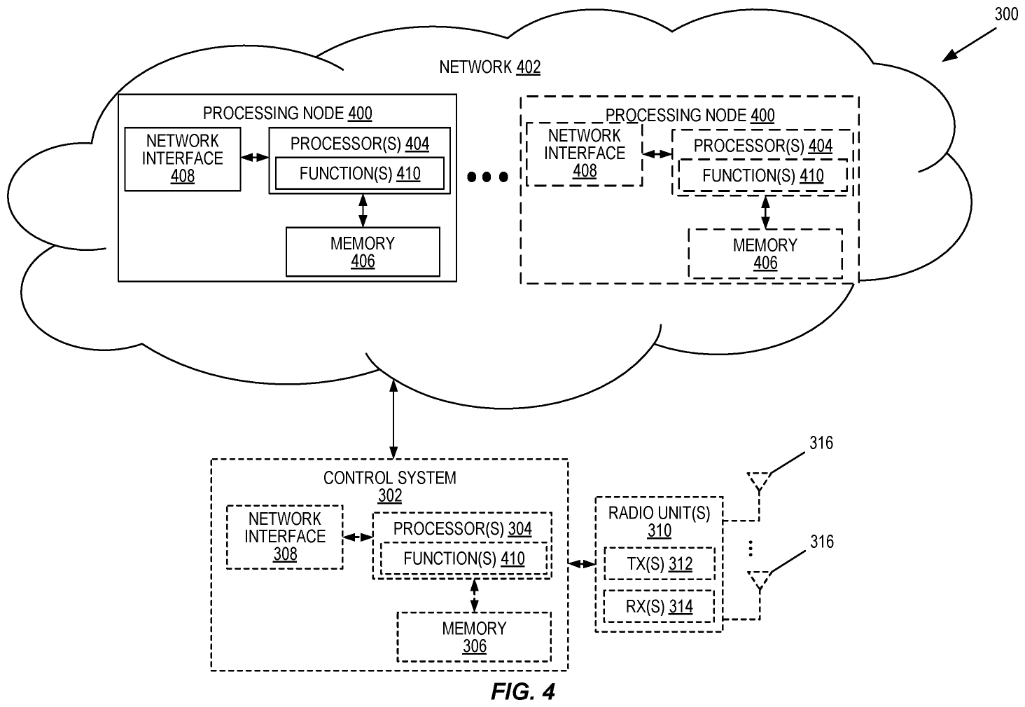

FIG. 4 is a schematic block diagram that illustrates a virtualized embodiment of the radio access node 300 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 300 in which at least a portion of the functionality of the radio access node 300 is implemented as a virtual component(s) (e.g., via a virtual machine(s) executing on a physical processing node(s) in a network(s)). As illustrated, in this example, the radio access node 300 may include the control system 302 and/or the one or more radio units 310, as described above. The control system 302 may be connected to the radio unit(s) 310 via, for example, an optical cable or the like. The radio access node 300 includes one or more processing nodes 400 coupled to or included as part of a network(s) 402. If present, the control system 302 or the radio unit(s) are connected to the processing node(s) 400 via the network 402. Each processing node 400 includes one or more processors 404 (e.g., CPUs, ASICs, FPGAs, and/or the like), memory 406, and a network interface 408.

In this example, functions 410 of the radio access node 300 described herein are implemented at the one or more processing nodes 400 or distributed across the one or more processing nodes 400 and the control system 302 and/or the radio unit(s) 310 in any desired manner. In some particular embodiments, some or all of the functions 410 of the radio access node 300 described herein are implemented as virtual components executed by one or more virtual machines implemented in a virtual environment(s) hosted by the processing node(s) 400. As will be appreciated by one of ordinary skill in the art, additional signaling or communication between the processing node(s) 400 and the control system 302 is used in order to carry out at least some of the desired functions 410. Notably, in some embodiments, the control system 302 may not be included, in which case the radio unit(s) 310 communicate directly with the processing node(s) 400 via an appropriate network interface(s).

In some embodiments, a computer program including instructions which, when executed by at least one processor, causes the at least one processor to carry out the functionality of radio access node 300 or a node (e.g., a processing node 400) implementing one or more of the functions 410 of the radio access node 300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 5 is a schematic block diagram of the radio access node 300 according to some other embodiments of the present disclosure. The radio access node 300 includes one or more modules 500, each of which is implemented in software. The module(s) 500 provide the functionality of the radio access node 300 described herein. This discussion is equally applicable to the processing node 400 of FIG. 4 where the modules 500 may be implemented at one of the processing nodes 400 or distributed across multiple processing nodes 400 and/or distributed across the processing node(s) 400 and the control system 302.

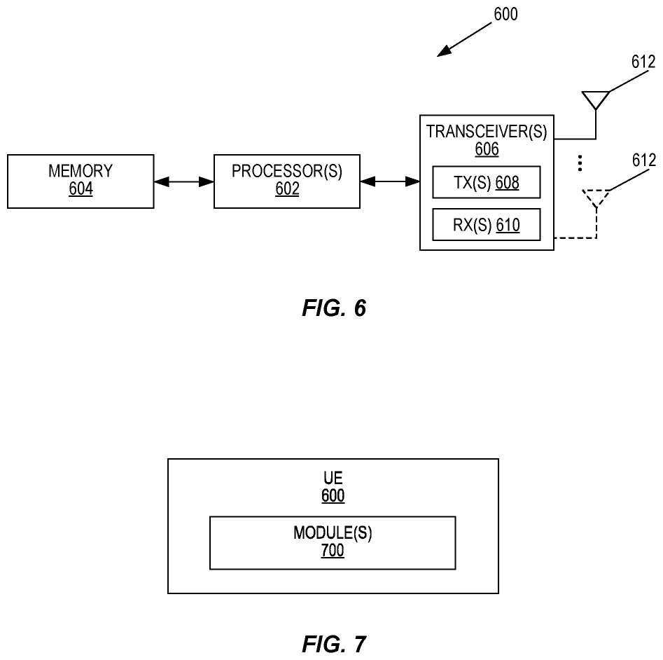

FIG. 6 is a schematic block diagram of a wireless communication device 600 according to some embodiments of the present disclosure. As illustrated, the wireless communication device 600 includes one or more processors 602 (e.g., CPUs, ASICs, FPGAs, and/or the like), memory 604, and one or more transceivers 606 each including one or more transmitters 608 and one or more receivers 610 coupled to one or more antennas 612. The transceiver(s) 606 includes radio-front end circuitry connected to the antenna(s) 612 that is configured to condition signals communicated between the antenna(s) 612 and the processor(s) 602, as will be appreciated by on of ordinary skill in the art. The processors 602 are also referred to herein as processing circuitry. The transceivers 606 are also referred to herein as radio circuitry. In some embodiments, the functionality of the wireless communication device 600 described above may be fully or partially implemented in software that is, e.g., stored in the memory 604 and executed by the processor(s) 602. Note that the wireless communication device 600 may include additional components not illustrated in FIG. 6 such as, e.g., one or more user interface components (e.g., an input/output interface including a display, buttons, a touch screen, a microphone, a speaker(s), and/or the like and/or any other components for allowing input of information into the wireless communication device 600 and/or allowing output of information from the wireless communication device 600), a power supply (e.g., a battery and associated power circuitry), etc.

In some embodiments, a computer program including instructions which, when executed by at least one processor, causes the at least one processor to carry out the functionality of the wireless communication device 600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the wireless communication device 600 according to some other embodiments of the present disclosure. The wireless communication device 600 includes one or more modules 700, each of which is implemented in software. The module(s) 700 provide the functionality of the wireless communication device 600 described herein.

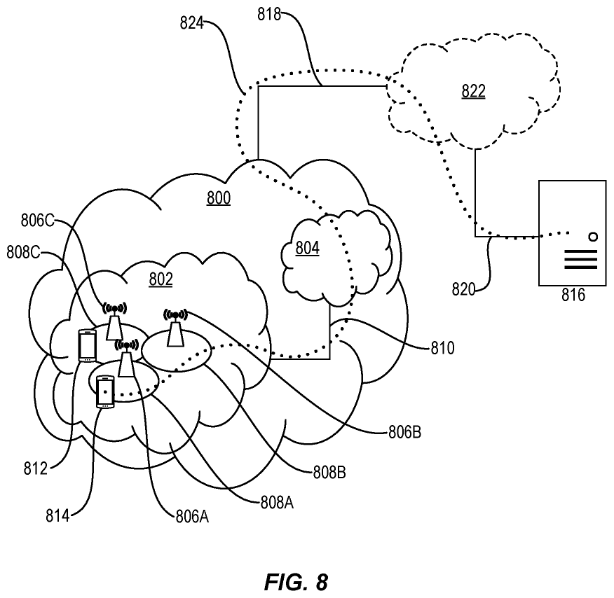

With reference to FIG. 8, in accordance with an embodiment, a communication system includes a telecommunication network 800, such as a 3GPP-type cellular network, which comprises an access network 802, such as a RAN, and a core network 804. The access network 802 comprises a plurality of base stations 806A, 806B, 806C, such as Node Bs, eNBs, gNBs, or other types of wireless Access Points (APs), each defining a corresponding coverage area 808A, 808B, 808C. Each base station 806A, 806B, 806C is connectable to the core network 804 over a wired or wireless connection 810. A first UE 812 located in coverage area 808C is configured to wirelessly connect to, or be paged by, the corresponding base station 806C. A second UE 814 in coverage area 808A is wirelessly connectable to the corresponding base station 806A. While a plurality of UEs 812, 814 are illustrated in this example, the disclosed embodiments are equally applicable to a situation where a sole UE is in the coverage area or where a sole UE is connecting to the corresponding base station 806.

The telecommunication network 800 is itself connected to a host computer 816, which may be embodied in the hardware and/or software of a standalone server, a cloud-implemented server, a distributed server, or as processing resources in a server farm. The host computer 816 may be under the ownership or control of a service provider, or may be operated by the service provider or on behalf of the service provider. Connections 818 and 820 between the telecommunication network 800 and the host computer 816 may extend directly from the core network 804 to the host computer 816 or may go via an optional intermediate network 822. The intermediate network 822 may be one of, or a combination of more than one of, a public, private, or hosted network; the intermediate network 822, if any, may be a backbone network or the Internet; in particular, the intermediate network 822 may comprise two or more sub-networks (not shown).

The communication system of FIG. 8 as a whole enables connectivity between the connected UEs 812, 814 and the host computer 816. The connectivity may be described as an Over-the-Top (OTT) connection 824. The host computer 816 and the connected UEs 812, 814 are configured to communicate data and/or signaling via the OTT connection 824, using the access network 802, the core network 804, any intermediate network 822, and possible further infrastructure (not shown) as intermediaries. The OTT connection 824 may be transparent in the sense that the participating communication devices through which the OTT connection 824 passes are unaware of routing of uplink and downlink communications. For example, the base station 806 may not or need not be informed about the past routing of an incoming downlink communication with data originating from the host computer 816 to be forwarded (e.g., handed over) to a connected UE 812. Similarly, the base station 806 need not be aware of the future routing of an outgoing uplink communication originating from the UE 812 towards the host computer 816.

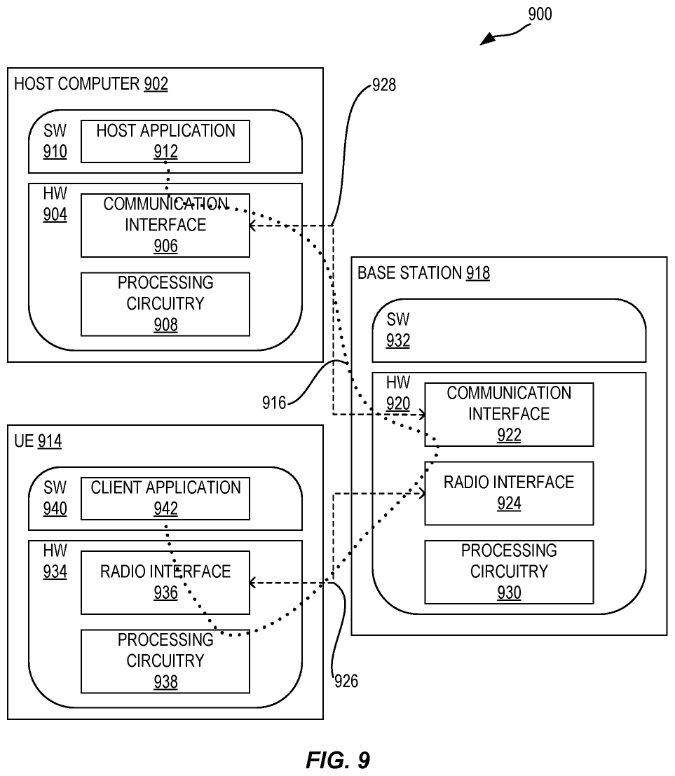

Example implementations, in accordance with an embodiment, of the UE, base station, and host computer discussed in the preceding paragraphs will now be described with reference to FIG. 9. In a communication system 900, a host computer 902 comprises hardware 904 including a communication interface 906 configured to set up and maintain a wired or wireless connection with an interface of a different communication device of the communication system 900. The host computer 902 further comprises processing circuitry 908, which may have storage and/or processing capabilities. In particular, the processing circuitry 908 may comprise one or more programmable processors, ASICs, FPGAs, or combinations of these (not shown) adapted to execute instructions. The host computer 902 further comprises software 910, which is stored in or accessible by the host computer 902 and executable by the processing circuitry 908. The software 910 includes a host application 912. The host application 912 may be operable to provide a service to a remote user, such as a UE 914 connecting via an OTT connection 916 terminating at the UE 914 and the host computer 902. In providing the service to the remote user, the host application 912 may provide user data which is transmitted using the OTT connection 916.

The communication system 900 further includes a base station 918 provided in a telecommunication system and comprising hardware 920 enabling it to communicate with the host computer 902 and with the UE 914. The hardware 920 may include a communication interface 922 for setting up and maintaining a wired or wireless connection with an interface of a different communication device of the communication system 900, as well as a radio interface 924 for setting up and maintaining at least a wireless connection 926 with the UE 914 located in a coverage area (not shown in FIG. 9) served by the base station 918. The communication interface 922 may be configured to facilitate a connection 928 to the host computer 902. The connection 928 may be direct or it may pass through a core network (not shown in FIG. 9) of the telecommunication system and/or through one or more intermediate networks outside the telecommunication system. In the embodiment shown, the hardware 920 of the base station 918 further includes processing circuitry 930, which may comprise one or more programmable processors, ASICs, FPGAs, or combinations of these (not shown) adapted to execute instructions. The base station 918 further has software 932 stored internally or accessible via an external connection.

The communication system 900 further includes the UE 914 already referred to. The UE's 914 hardware 934 may include a radio interface 936 configured to set up and maintain a wireless connection 926 with a base station serving a coverage area in which the UE 914 is currently located. The hardware 934 of the UE 914 further includes processing circuitry 938, which may comprise one or more programmable processors, ASICs, FPGAs, or combinations of these (not shown) adapted to execute instructions. The UE 914 further comprises software 940, which is stored in or accessible by the UE 914 and executable by the processing circuitry 938. The software 940 includes a client application 942. The client application 942 may be operable to provide a service to a human or non-human user via the UE 914, with the support of the host computer 902. In the host computer 902, the executing host application 912 may communicate with the executing client application 942 via the OTT connection 916 terminating at the UE 914 and the host computer 902. In providing the service to the user, the client application 942 may receive request data from the host application 912 and provide user data in response to the request data. The OTT connection 916 may transfer both the request data and the user data. The client application 942 may interact with the user to generate the user data that it provides.

It is noted that the host computer 902, the base station 918, and the UE 914 illustrated in FIG. 9 may be similar or identical to the host computer 816, one of the base stations 806A, 806B, 806C, and one of the UEs 812, 814 of FIG. 8, respectively. This is to say, the inner workings of these entities may be as shown in FIG. 9 and independently, the surrounding network topology may be that of FIG. 8.

In FIG. 9, the OTT connection 916 has been drawn abstractly to illustrate the communication between the host computer 902 and the UE 914 via the base station 918 without explicit reference to any intermediary devices and the precise routing of messages via these devices. The network infrastructure may determine the routing, which may be configured to hide from the UE 914 or from the service provider operating the host computer 902, or both. While the OTT connection 916 is active, the network infrastructure may further take decisions by which it dynamically changes the routing (e.g., on the basis of load balancing consideration or reconfiguration of the network).

The wireless connection 926 between the UE 914 and the base station 918 is in accordance with the teachings of the embodiments described throughout this disclosure. One or more of the various embodiments improve the performance of OTT services provided to the UE 914 using the OTT connection 916, in which the wireless connection 926 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 916 between the host computer 902 and the UE 914, in response to variations in the measurement results. The measurement procedure and/or the network functionality for reconfiguring the OTT connection 916 may be implemented in the software 910 and the hardware 904 of the host computer 902 or in the software 940 and the hardware 934 of the UE 914, or both. In some embodiments, sensors (not shown) may be deployed in or in association with communication devices through which the OTT connection 916 passes; the sensors may participate in the measurement procedure by supplying values of the monitored quantities exemplified above, or supplying values of other physical quantities from which the software 910, 940 may compute or estimate the monitored quantities. The reconfiguring of the OTT connection 916 may include message format, retransmission settings, preferred routing, etc.; the reconfiguring need not affect the base station 918, and it may be unknown or imperceptible to the base station 918. Such procedures and functionalities may be known and practiced in the art. In certain embodiments, measurements may involve proprietary UE signaling facilitating the host computer 902's measurements of throughput, propagation times, latency, and the like. The measurements may be implemented in that the software 910 and 940 causes messages to be transmitted, in particular empty or ‘dummy’ messages, using the OTT connection 916 while it monitors propagation times, errors, etc.

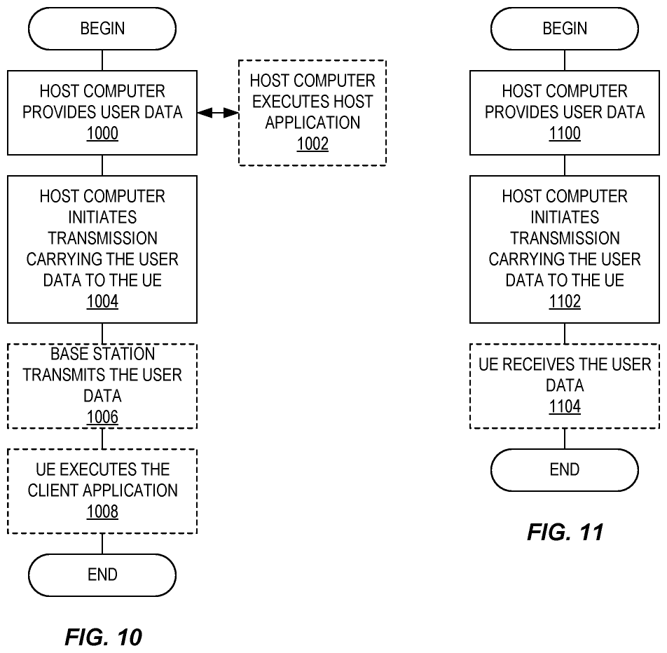

FIG. 10 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 10 will be included in this section. In step 1000, the host computer provides user data. In sub-step 1002 (which may be optional) of step 1000, the host computer provides the user data by executing a host application. In step 1004, the host computer initiates a transmission carrying the user data to the UE. In step 1006 (which may be optional), the base station transmits to the UE the user data which was carried in the transmission that the host computer initiated, in accordance with the teachings of the embodiments described throughout this disclosure. In step 1008 (which may also be optional), the UE executes a client application associated with the host application executed by the host computer.

FIG. 11 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 11 will be included in this section. In step 1100 of the method, the host computer provides user data. In an optional sub-step (not shown) the host computer provides the user data by executing a host application. In step 1102, the host computer initiates a transmission carrying the user data to the UE. The transmission may pass via the base station, in accordance with the teachings of the embodiments described throughout this disclosure. In step 1104 (which may be optional), the UE receives the user data carried in the transmission.

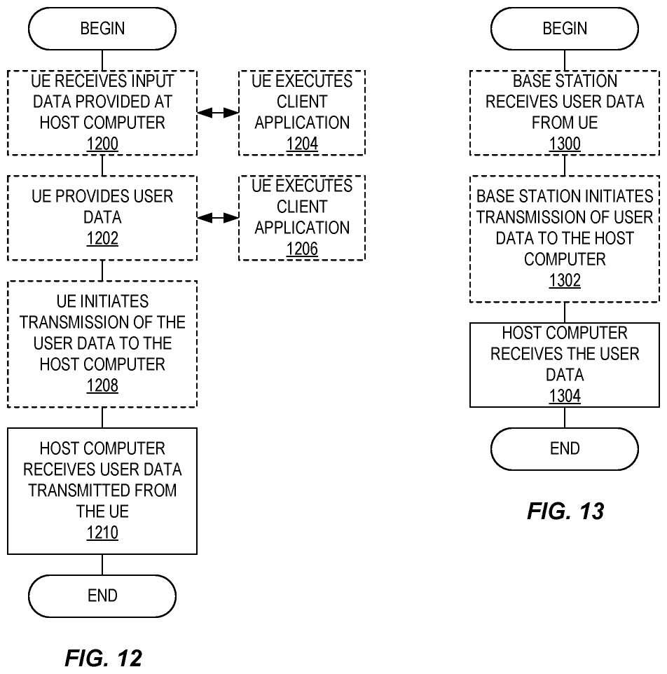

FIG. 12 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 12 will be included in this section. In step 1200 (which may be optional), the UE receives input data provided by the host computer. Additionally or alternatively, in step 1202, the UE provides user data. In sub-step 1204 (which may be optional) of step 1200, the UE provides the user data by executing a client application. In sub-step 1206 (which may be optional) of step 1202, the UE executes a client application which provides the user data in reaction to the received input data provided by the host computer. In providing the user data, the executed client application may further consider user input received from the user. Regardless of the specific manner in which the user data was provided, the UE initiates, in sub-step 1208 (which may be optional), transmission of the user data to the host computer. In step 1210 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 13 will be included in this section. In step 1300 (which may be optional), in accordance with the teachings of the embodiments described throughout this disclosure, the base station receives user data from the UE. In step 1302 (which may be optional), the base station initiates transmission of the received user data to the host computer. In step 1304 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group a Embodiments

Embodiment 1: A method performed by a wireless device, the method comprising one or more of: determining whether or not to use LBT for transmissions; transmitting based on the determination; determining whether or not a base station is using LBT for transmissions; and receiving transmission from the base station based on the determination.

Embodiment 2: The method of embodiment 1 wherein one or more of the determining steps is based on the configuration of the systems, device hardware capabilities, or predefined rules.

Embodiment 3: The method of any of embodiments 1-2 wherein one or more of the determining steps is based on satisfaction of one or more of the following thresholds or conditions: a. the number of antennas at the transmitter is larger than a certain threshold. The number of antennas to be considered could be the total equipped antennas or a sub-set of total antennas used for transmitting. b. the directivity of the transmissions from the transmitter is larger than a certain threshold; i. the directivity to be considered could include beamforming gain and antenna gain. ii. the beamforming gain to be considered could be long-term averaged or instantaneous; c. the transmit power or EIRP is smaller than a certain threshold. The transmit power and EIRP to be considered could be average or peak power. d. The transmit duration or duty cycle is smaller than a certain threshold. e. The scenario of network, e.g., controlled environment, or no coexistence with other networks, or no coexistence with other technologies. Input to this could be: i. Configured information in the gNB (configured through operation and maintenance means). ii. Information collected from Automatic Neighbor Relation (ANR) reports or similar reports from UEs about the presence of neighbor cells, gNBs, access points, networks, etc. in the area. iii. Information collected from centralized spectrum allocation entities.

Embodiment 4: The method of any of the previous embodiments wherein determining whether or not to use LBT for transmissions comprises transmitting without performing LBT prior to the transmission based on one or more of: a. receiving signaling from the base station, that indicates the wireless device may transmit without LBT (e.g., the indication can be based on RRC configuration or signaled via MAC-CE or DCI) E.g.: i. No LBT mode indication from base station via system information broadcasting. ii. No LBT mode activation from base station via dedicated RRC signaling (e.g., the wireless device will use no LBT mode until receiving another notification from base station or based on a timer). iii. No LBT mode activation from base station via MAC CE (e.g., the wireless device will use no LBT mode until receiving another notification from base station or based on a timer). iv. No LBT mode indication via the UL grant from base station, e.g., base station signal cat1 LBT in DCI for each transmission; b. receiving an indication regarding the conditions in which it is allowed to transmit without performing an LBT (e.g., the wireless device could operate without LBT or change from LBT to no LBT mode by itself if the above thresholds or conditions is satisfied. For instance, the wireless device is RRC configured with those thresholds or conditions. Embodiment 5: The method of any of embodiments 1-4 wherein one or more of the determining steps is based on the collision rates or unsuccessful transmission rate of the DL or/and UL transmissions observed over a certain period.

Embodiment 6: The method of embodiment 5 wherein, if the base station/wireless device counts the number of NACK over an observation period is larger than a certain threshold, it will change from no LBT to LBT mode.

Embodiment 7: The method of any of embodiments 1-6 wherein one or more of the determining steps comprises: measuring the ACK/NACK ratio over a period of time and trying to keep it at a particular target (e.g., 10%) using a control loop (e.g., if ACK/NACK ratio is larger than the target, LBT mode is used; Otherwise, no LBT mode is used).

Embodiment 8: The method of any of embodiments 1-7 wherein one or more of the determining steps comprises: determining based on the current or typical situation of aspects impacting interference between nodes and devices in the area, e.g., the number active wireless devices in the base station's cell (and neighbor cell), the traffic load measured by one or more metrics, e.g., the packet arrival rate, and so on).

Embodiment 9: The method of any of embodiments 1-8 wherein one or more of the determining steps comprises: determining based on the SINR of the uplinks for the wireless devices being served by the base station.

Embodiment 10: The method of any of embodiments 1-9 wherein one or more of the determining steps comprises: determining based on the SINR of the downlink from the base station (e.g., if the SINR is lower than a certain threshold, LBT mode is used).

Embodiment 11: The method of any of embodiments 1-10 wherein the modulation and coding rate (MCS) is jointly chosen together with the LBT mode.

Embodiment 12: The method of any of embodiments 1-11 wherein one or more of the determining steps comprises: taking into account the latency requirement of the data to be sent.

Embodiment 13: The method of any of embodiments 1-12 wherein one or more of the determining steps comprises: determining based at least in part on base station declaration of radio link failure.

Embodiment 14: The method of any of embodiments 1-13 wherein one or more of the determining steps comprises: determining based at least in part on its declaration of layer 1 control message failure (DCI and/or UCI).

Embodiment 15: The method of any of embodiments 1-14 wherein one or more of the determining steps comprises: determining based at least in part on the CSI measurement report from the wireless device.

Embodiment 16: The method of any of embodiments 1-15 wherein one or more of the determining steps comprises: determining based at least in part on wireless device declaration of radio link failure and subsequent RRC Connection Re-establishment attempts.

Embodiment 17: The method of any of embodiments 1-16 wherein one or more of the determining steps comprises: determining based on the average measured energy on the channel, i.e., the energy detected over a certain time duration where the time duration may be greater than the measurement slot sizes used in the LBT procedure.

Embodiment 18: The method of any of embodiments 1-17 wherein one or more of the determining steps comprises: determining based on the RSSI measurement on the operation channel during idle time (i.e., no active DL or UL transmission in the cell) within a certain time window (e.g., if the measured RSSI during idle time is below a certain threshold, no LBT could be used).

Embodiment 19: The method of any of embodiments 1-18 wherein one or more of the determining steps comprises: determining based on the one or a combination of more than one set of statistics from all or a subset of the active wireless devices.

Embodiment 20: The method of any of embodiments 1-19 wherein one or more of the determining steps comprises: determining based on the one or a combination of: a. a combination of more than one set of statistics; b. the receiver sensitivity measured by the received signal strength corresponding to the lowest successful MCS received from the wireless device/base station over an observation period; c. the type of transmission or signal; d. at least in part on information of how harmful interference (if any) the transmitter would cause for other devices in the area; e. information of how often the receiver fails to receive the transmission, or what SINR the receiver of the transmission experiences; f. statistics of the detected energy level; and g. performance metrics such as cell throughput, user throughput including mean and fifth percentile throughput, mean latency, fifth percentile latency etc.

Embodiment 21: The method of any of embodiments 1-20 wherein the different LBT mode could be selected for different signals.

Embodiment 22: The method of any of embodiments 1-21 wherein the LBT mode is signaled using L1 signaling.

Embodiment 23: The method of any of embodiments 1-22 wherein the base station makes sure that the wireless device UL transmissions are part of the base station's initiated COT.

Embodiment 24: The method of any of the previous embodiments, further comprising: providing user data; and forwarding the user data to a host computer via the transmission to the base station.

### Group B Embodiments

Embodiment 25: A method performed by a base station, the method comprising one or more of: determining whether or not to use LBT for transmissions; transmitting based on the determination; determining whether or not a wireless device is using LBT for transmissions; and receiving transmission from the wireless device based on the determination.

Embodiment 26: The method of embodiment 25 wherein one or more of the determining steps is based on the configuration of the systems, device hardware capabilities, or predefined rules.

Embodiment 27: The method of any of embodiments 25-26 wherein one or more of the determining steps is based on satisfaction of one or more of the following thresholds or conditions: a. the number of antennas at the transmitter is larger than a certain threshold. The number of antennas to be considered could be the total equipped antennas or a sub-set of total antennas used for transmitting. b. the directivity of the transmissions from the transmitter is larger than a certain threshold; i. the directivity to be considered could include beamforming gain and antenna gain. ii. the beamforming gain to be considered could be long-term averaged or instantaneous; c. the transmit power or EIRP is smaller than a certain threshold. The transmit power and EIRP to be considered could be average or peak power. d. The transmit duration or duty cycle is smaller than a certain threshold. e. The scenario of network, e.g., controlled environment, or no coexistence with other networks, or no coexistence with other technologies. Input to this could be: i. Configured information in the gNB (configured through operation and maintenance means). ii. Information collected from Automatic Neighbor Relation (ANR) reports or similar reports from UEs about the presence of neighbor cells, gNBs, access points, networks, etc. in the area. iii. Information collected from centralized spectrum allocation entities.

Embodiment 28: The method of any of the previous embodiments wherein determining whether or not to use LBT for transmissions comprises transmitting without performing LBT prior to the transmission based on one or more of: a. receiving signaling from the base station, that indicates the wireless device may transmit without LBT (e.g., the indication can be based on RRC configuration or signaled via MAC-CE or DCI) E.g.: i. No LBT mode indication from base station via system information broadcasting. ii. No LBT mode activation from base station via dedicated RRC signaling (e.g., the wireless device will use no LBT mode until receiving another notification from base station or based on a timer). iii. No LBT mode activation from base station via MAC CE (e.g., the wireless device will use no LBT mode until receiving another notification from base station or based on a timer). iv. No LBT mode indication via the UL grant from base station, e.g., base station signal cat1 LBT in DCI for each transmission; b. receiving an indication regarding the conditions in which it is allowed to transmit without performing an LBT (e.g., the wireless device could operate without LBT or change from LBT to no LBT mode by itself if the above thresholds or conditions is satisfied. For instance, the wireless device is RRC configured with those thresholds or conditions.

Embodiment 29: The method of any of embodiments 25-28 wherein one or more of the determining steps is based on the collision rates or unsuccessful transmission rate of the DL or/and UL transmissions observed over a certain period.

Embodiment 30: The method of embodiment 29 wherein, if the base station/wireless device counts the number of NACK over an observation period is larger than a certain threshold, it will change from no LBT to LBT mode.

Embodiment 31: The method of any of embodiments 25-30 wherein one or more of the determining steps comprises: measuring the ACK/NACK ratio over a period of time and trying to keep it at a particular target (e.g., 10%) using a control loop (e.g., if ACK/NACK ratio is larger than the target, LBT mode is used; Otherwise, no LBT mode is used).

Embodiment 32: The method of any of embodiments 25-31 wherein one or more of the determining steps comprises: determining based on the current or typical situation of aspects impacting interference between nodes and devices in the area, e.g., the number active wireless devices in the base station's cell (and neighbor cell), the traffic load measured by one or more metrics, e.g., the packet arrival rate, and so on).

Embodiment 33: The method of any of embodiments 25-32 wherein one or more of the determining steps comprises: determining based on the SINR of the uplinks for the wireless devices being served by the base station.

Embodiment 34: The method of any of embodiments 25-33 wherein one or more of the determining steps comprises: determining based on the SINR of the downlink from the base station (e.g., if the SINR is lower than a certain threshold, LBT mode is used).

Embodiment 35: The method of any of embodiments 25-34 wherein the modulation and coding rate (MCS) is jointly chosen together with the LBT mode.

Embodiment 36: The method of any of embodiments 25-35 wherein one or more of the determining steps comprises: taking into account the latency requirement of the data to be sent.

Embodiment 37: The method of any of embodiments 25-36 wherein one or more of the determining steps comprises: determining based at least in part on base station declaration of radio link failure.

Embodiment 38: The method of any of embodiments 25-37 wherein one or more of the determining steps comprises: determining based at least in part on its declaration of layer 1 control message failure (DCI and/or UCI).

Embodiment 39: The method of any of embodiments 25-38 wherein one or more of the determining steps comprises: determining based at least in part on the CSI measurement report from the wireless device.

Embodiment 40: The method of any of embodiments 25-39 wherein one or more of the determining steps comprises: determining based at least in part on wireless device declaration of radio link failure and subsequent RRC Connection Re-establishment attempts.

Embodiment 41: The method of any of embodiments 25-40 wherein one or more of the determining steps comprises: determining based on the average measured energy on the channel, i.e., the energy detected over a certain time duration where the time duration may be greater than the measurement slot sizes used in the LBT procedure.

Embodiment 42: The method of any of embodiments 25-41 wherein one or more of the determining steps comprises: determining based on the RSSI measurement on the operation channel during idle time (i.e., no active DL or UL transmission in the cell) within a certain time window (e.g., if the measured RSSI during idle time is below a certain threshold, no LBT could be used).

Embodiment 43: The method of any of embodiments 25-42 wherein one or more of the determining steps comprises: determining based on the one or a combination of more than one set of statistics from all or a subset of the active wireless devices.

Embodiment 44: The method of any of embodiments 25-43 wherein one or more of the determining steps comprises: determining based on the one or a combination of: a. a combination of more than one set of statistics; b. the receiver sensitivity measured by the received signal strength corresponding to the lowest successful MCS received from the wireless device/base station over an observation period; c. the type of transmission or signal; d. at least in part on information of how harmful interference (if any) the transmitter would cause for other devices in the area; e. information of how often the receiver fails to receive the transmission, or what SINR the receiver of the transmission experiences; f. statistics of the detected energy level; and g. performance metrics such as cell throughput, user throughput including mean and fifth percentile throughput, mean latency, fifth percentile latency etc.

Embodiment 45: The method of any of embodiments 25-44 wherein the different LBT mode could be selected for different signals.

Embodiment 46: The method of any of embodiments 25-45 wherein the LBT mode is signaled using L1 signaling.

Embodiment 47: The method of any of embodiments 25-46 wherein the base station makes sure that the wireless device UL transmissions are part of the base station's initiated COT.

Embodiment 48: The method of any of the previous embodiments, further comprising: obtaining user data; and forwarding the user data to a host computer or a wireless device.

### Group C Embodiments

Embodiment 49: A wireless device, the wireless device comprising: processing circuitry configured to perform any of the steps of any of the Group A embodiments; and power supply circuitry configured to supply power to the wireless device.

Embodiment 50: A base station, the base station comprising: processing circuitry configured to perform any of the steps of any of the Group B embodiments; and power supply circuitry configured to supply power to the base station.

Embodiment 51: A User Equipment, UE, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 52: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 53: The communication system of the previous embodiment further including the base station.

Embodiment 54: The communication system of the previous 2 embodiments, further including the UE, wherein the UE is configured to communicate with the base station.

Embodiment 55: The communication system of the previous 3 embodiments, wherein: the processing circuitry of the host computer is configured to execute a host application, thereby providing the user data; and the UE comprises processing circuitry configured to execute a client application associated with the host application.

Embodiment 56: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 57: The method of the previous embodiment, further comprising, at the base station, transmitting the user data.

Embodiment 58: The method of the previous 2 embodiments, wherein the user data is provided at the host computer by executing a host application, the method further comprising, at the UE, executing a client application associated with the host application.

Embodiment 59: A User Equipment, UE, configured to communicate with a base station, the UE comprising a radio interface and processing circuitry configured to perform the method of the previous 3 embodiments.

Embodiment 60: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 61: The communication system of the previous embodiment, wherein the cellular network further includes a base station configured to communicate with the UE.

Embodiment 62: The communication system of the previous 2 embodiments, wherein: the processing circuitry of the host computer is configured to execute a host application, thereby providing the user data; and the UE's processing circuitry is configured to execute a client application associated with the host application.

Embodiment 63: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 64: The method of the previous embodiment, further comprising at the UE, receiving the user data from the base station.

Embodiment 65: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 66: The communication system of the previous embodiment, further including the UE.

Embodiment 67: The communication system of the previous 2 embodiments, further including the base station, wherein the base station comprises a radio interface configured to communicate with the UE and a communication interface configured to forward to the host computer the user data carried by a transmission from the UE to the base station.

Embodiment 68: The communication system of the previous 3 embodiments, wherein: the processing circuitry of the host computer is configured to execute a host application; and the UE's processing circuitry is configured to execute a client application associated with the host application, thereby providing the user data.

Embodiment 69: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 70: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 71: The method of the previous embodiment, further comprising, at the UE, providing the user data to the base station.

Embodiment 72: The method of the previous 2 embodiments, further comprising: at the UE, executing a client application, thereby providing the user data to be transmitted; and at the host computer, executing a host application associated with the client application.

Embodiment 73: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 74: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 75: The communication system of the previous embodiment further including the base station.

Embodiment 76: The communication system of the previous 2 embodiments, further including the UE, wherein the UE is configured to communicate with the base station.

Embodiment 77: The communication system of the previous 3 embodiments, wherein: the processing circuitry of the host computer is configured to execute a host application; and the UE is configured to execute a client application associated with the host application, thereby providing the user data to be received by the host computer.

Embodiment 78: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 79: The method of the previous embodiment, further comprising at the base station, receiving the user data from the UE.

Embodiment 80: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgement
AMF Access and Mobility Management Function
AN Access Network
ANR Automatic Neighbor Relation
AP Access Point
ASIC Application Specific Integrated Circuit
ATPC Automatic Transmit Power Control
AUSF Authentication Server Function
CCA Clear Channel Assessment
CE Control Element
CEPT European Conference of Postal and Telecommunications Administrations
COT Channel Occupancy Time
CPU Central Processing Unit
CSI Channel State Information
CW Contention Window
DCI Downlink Control Information
DL Downlink
DN Data Network
DSP Digital Signal Processor
ED Energy Detection
EIRP Effective Isotropically Radiated Power
eNB Enhanced or Evolved Node B
E-UTRA Evolved Universal Terrestrial Radio Access
FBE Frame Based Equipment
FPGA Field Programmable Gate Array
GC Group Communication
gNB New Radio Base Station
gNB-CU New Radio Base Station Central Unit
gNB-DU New Radio Base Station Distributed Unit
HARQ Hybrid Automatic Repeat Request
HSS Home Subscriber Server
IoT Internet of Things
LBE Load Based Equipment
LBT Listen Before Talk
LTE Long Term Evolution
MAC Medium Access Control
MAC-CE Medium Access Control Control Element
MCOT Maximum Channel Occupancy Time
MCS Modulation and Coding Scheme
MME Mobility Management Entity
MTC Machine Type Communication
NACK Negative Acknowledgement
NEF Network Exposure Function
NF Network Function
NR New Radio
NRF Network Function Repository Function
NR-U New Radio Unlicensed Spectrum
NSSF Network Slice Selection Function
OTT Over-the-Top
PC Personal Computer
PDCCH Physical Downlink Control Channel
PDSCH Physical Downlink Shared Channel
PCF Policy Control Function
P-GW Packet Data Network Gateway
PRACH Physical Random Access Channel
P-RNTI Paging Radio Network Temporary Identifier
PUCCH Physical Uplink Control Channel
PUSCH Physical Uplink Shared Channel
RA Random Access
RAM Random Access Memory
RAN Radio Access Network
RAT Radio Access Technology
RLC Radio Link Control
RLF Radio Link Failure
RLM Radio Link Monitoring
RNTI Radio Network Temporary Identifier
ROM Read Only Memory
RRC Radio Resource Control
RRH Remote Radio Head
RSSI Received Signal Strength Indicator
RTT Round Trip Time
SCEF Service Capability Exposure Function
SIB System Information Broadcasting
SINR Signal to Interference plus Noise Ratio
SMF Session Management Function
SSB Synchronization Signal Block
TDRA Time Domain Resource Allocation
TXOP Transmission Opportunity
Uplink Control Information
Unified Data Management
User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a wireless device, the method comprising:
receiving signaling from a base station indicative of whether or not the wireless device is to use Listen Before Talk, LBT, for transmissions;
determining whether or not to use LBT for transmissions, based on the received signaling and satisfaction of one or more of the following conditions:
the directivity of the transmissions from the transmitter is larger than a threshold,
the transmit power or Effective Isotropically Radiated Power, EIRP, is smaller than a threshold; and
transmitting based on the determination whether or not to use LBT for transmissions.

2. The method of claim 1 wherein the received signaling from the base station comprises an indication whether or not to use LBT.

3. (canceled)

4. The method of claim 1 wherein receiving the signaling from the base station comprising one or more of:
receiving signaling from the base station based on a Radio Resource Control, RRC, configuration;
receiving signaling from the base station via a Medium Access Control-Control Element, MAC-CE;
receiving signaling from the base station via a Downlink Control Information, DCI;
receiving signaling from the base station via System Information Broadcasting, SIB;
receiving signaling from the base station based on RRC configuration; and
receiving signaling from the base station in DCI for each transmission.

5-10. (canceled)

11. The method of claim 1 wherein a Modulation and Coding Scheme, MCS, is jointly chosen together with a LBT mode.

12. The method of claim 1 wherein determining whether or not to use LBT for transmissions further comprises: taking into account the latency requirement of data to be sent.

13-23. (canceled)

24. A method performed by a base station, the method comprising:
determining whether or not a wireless device should use Listen Before Talk, LBT, for transmissions based on satisfaction of one or more of the following conditions:
the directivity of the transmissions from the transmitter is larger than a threshold,
the transmit power or Effective Isotropically Radiated Power, EIRP, is smaller than a threshold;
transmitting signaling to the wireless device indicative of whether or not the wireless device is to use LBT for transmissions; and
receiving, from the wireless device, transmissions based on the determination whether or not to use LBT for transmissions.

25. The method of claim 24 wherein the transmitted signaling from the base station comprises an indication whether or not to use LBT.

26. (canceled)

27. The method of claim 24 wherein transmitting the signaling from the base station comprising one or more of:
transmitting signaling from the base station based on a Radio Resource Control, RRC, configuration;
transmitting signaling from the base station via a Medium Access Control-Control Element, MAC-CE;
transmitting signaling from the base station via a Downlink Control Information, DCI;
transmitting signaling from the base station via a System Information Broadcasting, SIB; and
transmitting signaling from the base station in DCI for each transmission.

28-33. (canceled)

34. The method of claim 24 wherein a Modulation and Coding Scheme, MCS, is jointly chosen together with a LBT mode.

35. The method of claim 24 wherein determining whether or not to use LBT for transmissions further comprises: taking into account the latency requirement of data to be sent.

36-47. (canceled)

48. A wireless device comprising:
one or more transmitters;
one or more receivers; and
processing circuitry associated with the one or more transmitters and the one or more receivers, the processing circuitry configured to cause the wireless device to:
receive signaling from a base station indicative of whether or not the wireless device is to use LBT for transmissions,
determine whether or not to use Listen Before Talk, LBT, for transmissions based on the received signaling and satisfaction of one or more of the following conditions:
the directivity of the transmissions from the transmitter is larger than a threshold,
the transmit power or Effective Isotropically Radiated Power, EIRP, is smaller than a threshold;
transmit based on the determination whether or not to use LBT for transmissions.

49. (canceled)

50. A base station comprising:
one or more transmitters;
one or more receivers; and
processing circuitry associated with the one or more transmitters and the one or more receivers, the processing circuitry configured to cause the base station to:
determine whether or not a wireless device should use Listen Before Talk, LBT, for transmissions based on the satisfaction of one or more of the following conditions:
the directivity of the transmissions from the transmitter is larger than a threshold,
the transmit power or Effective Isotropically Radiated Power, EIRP, is smaller than a threshold;
transmit signaling to the wireless device indicative of whether or not the wireless device is to use LBT for transmissions; and
receive, from the wireless device, transmissions based on the determination whether or not to use LBT for transmissions.

51. (canceled)
